(19) United States
(12) Patent Application Publication
(10) Pub. No.: US 2003/0217926 A1
(43) Pub. Date: Nov. 27, 2003

(54) Recovery of viruses

(75) Inventors: Kailing Wang, Carlingford (AU); Thomas Turton, Lane Cove (AU)

Correspondence Address: BAKER & MCKENZIE, 805 THIRD AVENUE, NEW YORK, NY, 10022, US

(73) Assignee: Gradipore Limited, Frenchs Forest NSW (AU)

(21) Appl. No.: 10/386,738

(22) Filed: Mar. 12, 2003

(30) Foreign Application Priority Data
Mar. 12, 2002 (AU) PS 1056

(51) Int. Cl. B01D 61/42; G01N 27/26

(52) U.S. Cl. 204/518; 204/543

(57) ABSTRACT

A method for recovering a desired virus type from a mixture of unwanted compounds places a mixture in a first sample chamber of an electrophoresis apparatus that contains a separation membrane located between the first sample chamber and a second sample chamber. Applying an electric potential across the first and second sample chambers separates at least a portion of one virus type on one side of the separation membrane while unwanted compounds are located on the other side of the separation membrane. Either the desired virus type or the unwanted molecules move through the separation membrane. The potential is applied until the required amount of desired virus type is located on one side of the separation membrane. Approximately 50% or more of the desired virus type that is located on one side of the separation membrane remains viable or substantially unchanged after recovery.

### FIELD

The present application relates to methods for recovery, separation and purification of viruses, particularly viral separation from mixtures thereof.

### BACKGROUND

Viruses are useful for a number of applications including vaccines, viral therapy, recombinant vectors, pesticides, and laboratory reagents. At present, viruses are grown in suitable cells for replication and are purified by techniques such as ultrafiltration, nanofiltration, ultracentrifugation, density gradient centrifugation and column chromatography. These traditional methods are frequently not able to rapidly or efficiently obtain viruses in substantially pure or unaltered states. Often, viruses purified by conventional means are contaminated by biological materials carried over from culture media or cell sources. Such contamination can be problematic for vaccines or other medical or veterinary uses.

Vaccines are products designed to stimulate the immune system so as to prevent the development of an infectious disease, or more recently, to aid in the treatment of certain cancers. Vaccine products encompass both virus and bacterial-derived vaccines as well as recombinant proteins and immunoglobulin preparations.

Live-attenuated virus vaccines have been successfully used to protect against a great number of disease, including polio and measles. Most of the live attenuated vaccines used today are derived from serial passage in cultured cells, including human diploid cells, monkey kidney cells and chick embryos. Whole inactivated virus vaccines have been successfully used for diseases such as polio and hepatitis A viruses. Inactivated viruses are also propagated on a cell culture line, but they are killed with the use of an inactivating agent such as formalin, B-propiolactone and ethylenimines. The overall goal is to destroy the infectivity of the virus, while maintaining its immunogenicity.

Once viruses have been propagated on the cell culture line, they undergo a purification process possibly involving cell lysis, ultrafiltration, centrifugation, and/or chromatography. The key challenge for the vaccine process in general is to enhance removal of endogenous and adventitious viruses and other pathogens from vaccine products. For examples, mammalian cell bio-reactors can become contaminated with adventitious viruses. The raw materials and substrates (cells, virus pool, FBS and human albumin) used in the manufacture of biological products may harbor adventitious agents including viruses and mycoplasma. The addition of mammalian blood serum to culture medium assists the attachment and growth of a wide variety of cells, however, FBS is likely to be associated with transmissible spongiform encephalopathy (TSE) contamination. Centrifugation and filtration are commonly used to concentrate and purify virus from the liquid media based on size and/or density, however, for enveloped viruses problems arise from the osmotic stress that virions are subjected to by high concentration of the density gradient forming reagent.

Mixtures of several types of viruses can be difficult to separate by conventional methods. For example, when a virus is propagated, contaminating adventitious viruses are unavoidably harvested with the target virus. Such viruses can be derived from the cell line or cell medium (particularly when serum based), or pre-existent in embryonated eggs. This represents a significant problem in vaccine production. Primary monkey kidney cell cultures were once used for the production of polio vaccines. At least 75 different simian viruses (some pathogenic) have been found in these cell lines. Additionally, avian leukosis viruses have been found in chicken embryonic fibroblast (CEF) substrates which are used for measles and mumps vaccine production. Because of this problem, separating target and contaminating virus is necessary for safe vaccine production.

Membrane-based electrophoresis technology processes raw material in a native or more natural state. During processing, material is exposed to minimal physical and chemical stresses. Maintaining intact virus particles is essential when virus structure is important for such applications as vaccine production. Electrophoresis treatment does not expose virus samples to the physical pressures encountered in conventional means of virus isolation and concentration such as ultra-centrifugation and pressure driven filtration. The harsh environments produced by these conventional processes reduce the yield of intact virus. Further, the multiple process steps that are currently used result in lower recovery and loss of infectivity.

Membrane-based electrophoresis is a technology originally developed for the separation of macromolecules such as proteins, nucleotides and complex sugars based upon its ability to separate according to small variations in size and charge. Preparative electrophoresis technology utilizes tangential flow across polyacrylamide membranes with an electric field or potential applied across the membranes. The general design of the system facilitates the purification of proteins and other macromolecules under near native conditions. This results in higher yields and excellent purity. The process provides a high purity, scalable separation that is often faster, cheaper and higher yielding than other methods of macromolecule separation. At present, membrane-based electrophoresis is not considered suitable for actually recovering or processing large entities such as viruses, microorganisms or cells due to limitations in processing entities larger than macromolecules.

Many commercial applications exist for a successful technology that recovers and purifies a virus. These applications range, for example, from vaccine purification to diagnostic tests. Although, membrane-based electrophoresis has recently been established as an effective means of pathogen removal, including removal of virus contaminants from pharmaceutical products, removal of virus in this mode results in the purification of a product essentially free from viral contamination. This technique does not, however, result in recovery or useful yield of viruses from such samples.

### SUMMARY

The present application provides methods of recovering or purifying a desired virus type from a mixture of compounds using a membrane-based electrophoresis separation system. These methods result in at least 50% of the separated desired virus type remaining viable or substantially unaltered after electrophoresis.

The present application also provides methods of recovering at least one desired type of virus from a mixture of two or more types of virus using a membrane-based electrophoresis separation system.

In one aspect, a method for recovering a desired virus type from a mixture of unwanted compounds by electrophoresis places a mixture in a first sample chamber of an electrophoresis apparatus comprising a separation membrane disposed between the first sample chamber and a second sample chamber. Applying an electric potential across the first and second sample chambers separates at least a portion of the desired virus type on one side of the separation membrane while unwanted compounds and virus types are located on the other side of the separation membrane. Either the desired virus type moves through the separation membrane or the unwanted compounds move through the separation membrane. The potential is applied until the required amount of desired virus type is recovered. At least about 50% of the desired virus type located on one side of the separation membrane remains viable or substantially unchanged upon recovery.

These and other features of the claims will be appreciated from review of the following detailed description of the application along with the accompanying figures.

### BRIEF DESCRIPTION OF THE DRAWINGS

FIG. 1 is a block diagram of a method for recovery of a desired virus type from a mixture of unwanted compounds by electrophoresis;

FIG. 2 is an SDS-PAGE analysis of protein contaminant transfer during a virus purification run showing transfer of albumin and transferrin (major bands visible); and

FIG. 3 shows results of the level of PPV quantified by end-point titration of samples detected by nested PCR.

### DETAILED DESCRIPTION

Embodiments for recovering or purifying a desired type of virus from a mixture of unwanted compounds or a mixture of two or more virus types using a membrane-based electrophoresis system are described in non-limiting detail below.

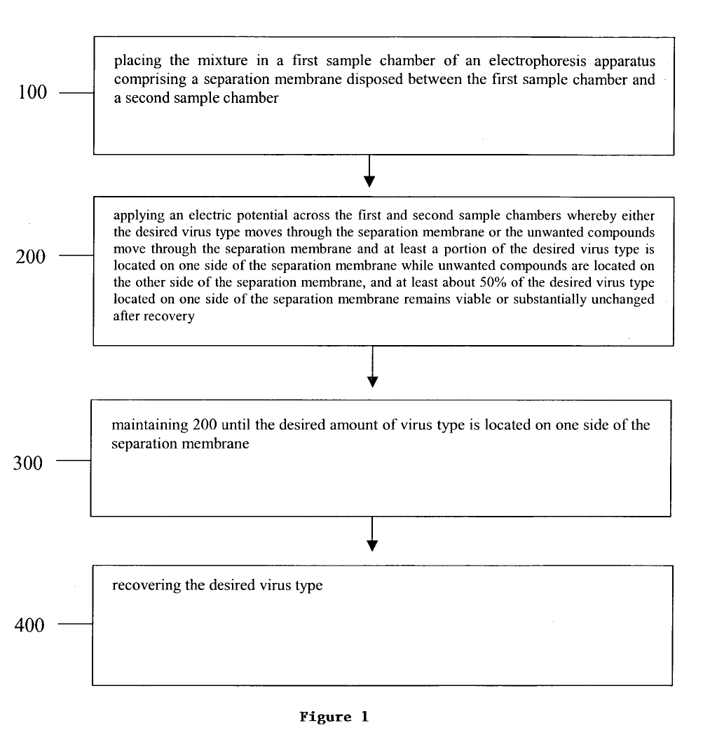

FIG. 1 refers to a block diagram of a method of recovering a desired virus type from a sample mixture of unwanted compounds by electrophoresis. In one embodiment, the method separates one virus type from a sample mixture containing only two different virus types. In other embodiments, there may be a mixture of more than two virus types. For example, one virus type may be recovered from a mixture of three or four different virus types using the methods described herein. As another example, a mixture of five different virus types may be separated into a portion containing two virus types and a portion containing three virus types. One of ordinary skill in the art understands that other combinations of virus types may be separated using the methods described herein. In another embodiment, a single desired virus type may be recovered from a sample containing the single virus type and other unwanted materials. For example, a desired virus type may be recovered from a cell lysate or supernatant in which the virus has been propagated.

The virus types may be derived from the same viral species but have different characteristics, such as different attenuation states, infectivity, or physical or biological attributes. During electrophoresis, these differences may be exploited to assist in selective recovery of desired virus(es). The virus types may also be of different viral species. In one embodiment, the desired virus is of the virus type parvovirus, picomavirus, paramyxovirus, orthomyxovirus or flavivirus. Other viral species may also be separated using the methods described herein, and those species are readily identifiable by one of ordinary skill in the art based on the attenuation state, physical or biological attributes of the virus type during electrophoresis.

Referring to FIG. 1, block 100 depicts placing a sample mixture containing a desired virus type and unwanted compounds in a first sample chamber of an electrophoresis apparatus comprising a separation membrane disposed between the first sample chamber and a second sample chamber.

A suitable electrophoresis apparatus contains a separation membrane. In one embodiment, the separation membrane is ion permeable and prevents convective mixing between adjacent chambers of the apparatus. The separation membrane is placed in an electric field and components of the sample mixture are selectively transported through the separation membrane. One of ordinary skill in the art understands that the particular separation membrane used will vary depending on the viruses to be separated and generally have characteristic average pore sizes, pore size distributions and/or isoelectric points. The different characteristics of the separation membrane either allow or substantially prevent passage of different components through the separation membrane. The selection of a suitable separation membrane based on the size and/or pI value of the desired virus type(s) is readily ascertainable by the skilled practitioner.

In one embodiment, the separation membrane is an isoelectric membrane having a characteristic pH value. In another embodiment, the isoelectric membrane has a pH value in a range of about 2 to 12. Suitable isoelectric membranes may be produced, for example, by copolymerizing acrylamide, N,N′-methylene bisacrylamide and appropriate acrylamide derivatives of weak electrolytes yielding isoelectric membranes. In one embodiment, isoelectric membranes are Immobiline™ polyacrylamide membranes. It will be appreciated, however, that other membranes are also suitable and may be formed by other suitable processes.

The separation membrane in another embodiment is made from polyacrylamide and has a molecular mass cut-off of at least about 5 kDa. Other embodiments may have different molecular mass cut-offs as the size of the molecular mass cut-off of the membrane will depend on the sample being processed, the other molecules or compounds in the sample mixture, and the type of separation carried out. The use of non-conventional membranes, such as isoelectric focusing (IEF) membranes may also be used.

In one embodiment, the apparatus includes a cartridge which houses a number of membranes forming at least two chambers, a cathode and an anode in respective electrode chambers connected to a suitable power supply, reservoirs for samples, buffers and electrolytes, pumps for passing samples, buffers and electrolytes, and cooling means to maintain samples, buffers and electrolytes at a required temperature during electrophoresis. The cartridge typically contains at least three substantially planar membranes disposed and spaced relative to each other to form two chambers through which sample or solvent can be passed. A separation membrane is disposed between two outer membranes (termed restriction membranes as their molecular mass cut-offs are usually smaller than the cut-off of the separation membrane). When the cartridge is installed in the apparatus, the restriction membranes are typically located adjacent to an electrode. One suitable cartridge is described in AU 738361.

In another embodiment, the sample mixture containing at least one virus type is placed in an electrophoresis apparatus comprising a first electrolyte chamber, a second electrolyte chamber, a first sample chamber disposed between the first electrolyte chamber and the second electrolyte chamber, a second sample chamber disposed adjacent to the first sample chamber and between the first electrolyte chamber and the second electrolyte chamber, a first ion-permeable barrier disposed between the first sample chamber and the second sample chamber, the first ion-permeable barrier prevents substantial convective mixing of contents of the first and second sample chambers; a second ion-permeable barrier disposed between the first electrolyte chamber and the first sample chamber, the second ion-permeable barrier prevents substantial convective mixing of contents of the first electrolyte chamber and the first sample chamber; a third ion-permeable barrier disposed between the second sample chamber and the second electrolyte chamber, the third ion-permeable barrier prevents substantial convective mixing of contents of the second electrolyte chamber and the second sample chamber. The electrodes are disposed in the first and second electrolyte chambers.

In one form, the first ion-permeable barrier is an electrophoresis separation membrane having a characteristic average pore size and pore size distribution. In another form, all the ion-permeable barriers are membranes having a characteristic average pore size and pore size distribution. This configuration of the apparatus is suitable for separating sample components on the basis of charge and or size.

The second and third barriers are typically restriction membranes having a molecular mass cut off less than that of the first membrane. In one embodiment, the restriction membrane is formed from polyacrylamide. The molecular mass cut-off of the restriction membranes will depend on the sample being processed, the other molecules or compounds in the sample mixture, and the type of separation carried out. It will be appreciated that the second ion-permeable barrier may have a different molecular mass cut off from the third ion-permeable barrier. In one embodiment, at least one of the second or third ion-permeable barriers is an isoelectric membrane having a characteristic pH value. In another embodiment, the isoelectric membrane has a pH value in a range of about 2 to 12. When both the second and third ion-permeable barriers are isoelectric membranes, the membranes may alternatively have the same or different characteristic pH values.

A first electrolyte reservoir is in fluid communication with an electrolyte chamber in one embodiment. A first sample reservoir is in fluid communication with the first sample chamber and a second sample reservoir is in fluid communication with a second sample chamber in another embodiment. In one aspect, electrolyte is provided to electrolyte chambers by means known to one of ordinary skill in the art. Similarly, sample or fluid is provided to the first or second sample chambers in another embodiment by means known to the ordinary practitioner. Another embodiment further includes the step of providing a first electrolyte to the first electrolyte chamber and a second electrolyte to the second electrolyte chamber.

In one form, electrolyte from an electrolyte reservoir(s) is circulated through the electrolyte chamber(s) to form an electrolyte stream(s). Electrolyte may be circulated through the first or second sample chamber forming a first or second sample stream through the respective first or second chamber. In another form, content of the first or second sample reservoir may be circulated through the first or second sample chamber forming a first or second sample stream through the respective first or second sample chamber. In another embodiment, sample or liquid in the first or second sample reservoir is removed and replaced with fresh sample or liquid.

Membrane-based electrophoresis apparatus (Gradiflow™) developed by, or in association with, Gradipore Limited, Australia are suitable for performing the methods described herein and are fully disclosed in commonly assigned U.S. Pat. Nos. 6,413,402; 6,328,869; 5,039,386; and 5,650,055, and incorporated by reference herein. Another apparatus suitable for the methods described herein is found in WO 02/24314 and is also incorporated by reference herein. One of ordinary skill in the art understands, however, that other suitable electrophoresis apparatus having a separation membrane disposed between a first sample chamber and a second sample chamber may also be used.

Referring back to FIG. 1, block 200 applies an electric potential across the first and second sample chambers of the electrophoresis apparatus, whereby either the desired virus type or the unwanted compounds move through the separation membrane and at least a portion of the desired virus type is located on one side of the separation membrane while unwanted compounds are located on the other side of the separation membrane. At least about 50% of the one virus type located on one side of the separation membrane remains viable or substantially unchanged after separation.

A virus remains viable or substantially unchanged after separation when the virus does not lose infectivity to a cell type or an animal (including non-attenuated or live viruses), or its antigenicity, serological properties, or physical properties are not substantially changed or altered (including non-attenuated, altered, attenuated, inactivated or killed viruses) after separation. In other embodiments, at least 60%, more preferably 70%, even more preferably 80%, or up to 90% of one virus type remains viable or substantially unchanged after separation.

Preferably, substantially all migration across the separation membrane occurs upon the application of the electric potential. For example, the desired virus type(s) migrate(s) across the separation membrane into the second sample chamber while the unwanted compounds in the sample, including the unwanted virus type(s) and unwanted non-viral material, are retained on the other side of the separation membrane. Alternatively, the unwanted virus type(s) and non-viral material, such as unwanted cellular or macromolecular material, migrate across the separation barrier while the desired virus type(s) is retained on the other side of the separation membrane. Carrier molecules may be used to alter the charge and/or size of a particular virus type to enhance or inhibit its migration across the separation membrane. In another embodiment, non-viral material is removed from a virus containing sample resulting in recovery of a purified virus type substantially free from unwanted non-viral material.

Referring to FIG. 1, block 300 maintains the potential applied in block 200 until a required amount of virus type is located on one side of the separation membrane. A required amount of virus may be recovered and extracted before complete separation of any given sample is effected. In one embodiment, the potential is maintained until the desired virus type reaches a requisite purity level in the first or second sample chamber or in the first or second sample reservoirs. Block 400 recovers the desired virus type. At least 50% of the recovered virus type remains viable or substantially unchanged after separation.

Blocks 100-400 may be repeated multiple times to recover and purify virus. Each repetition of blocks 100-400 is typically termed a “run.” The same separation membrane may be used in a successive run, or the separation membrane may be replaced with another separation membrane having different characteristics in a successive run.

The methods described herein may be performed on either a laboratory or industrial scale. The described methods may be used to purify vaccines or as a diagnostic kit to analyze samples for virus contamination. These methods may also be used to purify or concentrate virus for analysis. For example, the described methods may be performed on a sample of harvested cell culture supernatant. In addition to the original composition of the cell culture media, this material is contaminated with cellular debris including immunogenic substances and enzymes which potentially interfere with assays and digest proteins or DNA. As such, many cell culture media components are undesirable in vaccines. For example, bovine albumin and transferrin make up the vast majority of the total protein of the culture media when fetal calf serum is used, and need to be removed to provide a purified virus preparation. If cell culture is carried out under serum free conditions, proteins including transferrin, albumin and insulin are usually included in a defined media without much of the uncharacterized protein contamination present when using serum. As shown in experimental detail below, the methods described herein remove such proteins from virus.

As a tool for diagnostic kits, the described methods purify and concentrate blood, plasma, or body fluid to increase sensitivity to the detection method. A viral “clean up step” may be effected with the described methods and remove the major “contaminants” (proteins e.g., that block and reduce sensitivity of assays), and if necessary, concentrate the sample significantly to increase viral detection.

To assist in understanding the present claims, the following examples are included and describe the results of a series of experiments. The following examples relating to this application should not be construed to specifically limit the application or such variations of the application, now known or later developed, which fall within the scope of the application as described and claimed herein.

In the following examples, the term “stream 1 (S1)” refers to the first sample stream or first sample chamber. The term “stream 2 (S2)” refers to the second sample stream or second sample chamber. The term “forward polarity” is used when the first electrode is the cathode and the second electrode is the anode in the electrophoresis apparatus and current is applied accordingly. The term “reverse polarity” is used when polarity of the electrodes is reversed such that the first electrode becomes the anode and the second electrode becomes the cathode. The term “buffer” is intended to include solutions of electrolytes. The buffer is a solution that conducts electricity. The buffer maintains to some extent a pH of its environment.

### Analytical Methods

Apparatus

Typically, in a suitable electrophoresis apparatus, a sample was placed in the first and/or second sample reservoirs and circulated through the first and/or second sample chambers. Electrolyte was placed in the first and second electrolyte reservoirs and circulated through the respective first and second electrolyte chambers without causing substantial mixing between the electrolyte in the two electrolyte reservoirs. Electrolyte or other liquid was placed in the first and/or second sample reservoirs if required. An electric potential was applied to the electrodes whereby one or more components in the first and/or second sample chamber move through a separation membrane to the second and/or first sample chamber, or to the first and/or second reservoir chambers. Treated sample or product is collected in the second and/or first sample reservoir.

Methods

The following experiments establish methods for recovering a desired type of virus(s) from a mixture of unwanted compounds. Most experiments used cell culture media with 10% fetal bovine serum (FBS) as the start material, with either 2 mM or 100 mM base (NaOH) and acid (HCl) for the buffer streams.

Cell Culture Media

2 mM Acid/Base

Start material of cell culture media (DMEM+10% FBS) was diluted 1:1 with MilliQ water. Run times of 1 hour were used to complete transfer of protein. 250 volts, 1 amp and 150 watts was applied with forward polarity. The start material was loaded in stream one, stream two or in both streams. 2 mM NaOH and HCl was used for the upper (next to stream 1) and lower (next to stream 2) buffer streams respectively. A 1000 kDa-IEF/10 kDa cartridge was used with a pH 4.8 separation membrane.

100 mM Acid/Base

The run conditions were the same as above except that 100 mM NaOH and HCl was used for the two buffer streams. A PES/1000 kDa-IEF/PES cartridge was used with pH 4.8 and 5.0 membranes. A 10 kDa/1000 kDa-IEF/10 kDa cartridge was used with a pH 4.6 separation membrane for one run. Amphoteric molecules consisted of 30 mM lysine monohydrate in stream 1 and 19 mM aminobenzoic acid in stream 2 to assist in keeping pH stability within the streams.

Control Runs

Run conditions were the same as above except that the start material consisted of 4% BSA or 1:10 diluted egg white (both in MilliQ water). A 10 kDa/1000 kDa-IEF/10 kDa cartridge was used with a pH 4.6 separation membrane.

Polyacrylamide Gel Electrophoresis (PAGE)

PAGE was used to measure the movement of components during an electrophoresis run. Standard PAGE methods were employed as set out below.

Reagents: 10×SDS Glycine running buffer (Gradipore Limited, Australia), dilute using Milli-Q water to 1× for use; 1×SDS Glycine running buffer (29 g Trizma base, 144 g Glycine, 10 g SDS, make up in RO water to 1.0 L); 10×TBE II running buffer (Gradipore), dilute using Milli-Q water to 1× for use; 1×TBE II running buffer (10.8 g Trizma base, 5.5 g Boric acid, 0.75 g EDTA, make up in RO water to 1.0 L); 2×SDS sample buffer (4.0 ml, 10% (w/v) SDS electrophoresis grade, 2.0 ml Glycerol, 1.0 ml 0.1% (w/v) Bromophenol blue, 2.5 ml 0.5M Tris-HCl, pH 6.8, make up in RO water up to 10 ml); 2× Native sample buffer (10% (v/v) 10×TBE II, 20% (v/v) PEG 200, 0.1 g/L Xylene cyanole, 0.1 g/l Bromophenol blue, make up in RO water to 100%); Coomassie blue stain (Gradipure™, Gradipore). Note: contains methanol 6% Acetic Acid solution for de-stain.

Molecular weight markers (Recommended to store at −20° C.): SDS PAGE (e.g. Sigma wide range); Western Blotting (e.g. color/rainbow markers).

SDS PAGE With Non-Reduced Samples

To prepare the samples for running, 2×SDS sample buffer was added to sample at a 1:1 ratio (usually 50 μl/50 μl) in the microtiter plate wells or 1.5 ml tubes. The samples were incubated for 5 minutes at approximately 100° C. Gel cassettes were clipped onto the gel support with wells facing in, and placed in the tank. If only running one gel on a support, a blank cassette or plastic plate was clipped onto the other side of the support Sufficient 1×SDS glycine running buffer was poured into the inner tank of the gel support to cover the sample wells. The outer tank was filled to a level approximately midway up the gel cassette. Using a transfer pipette, the sample wells were rinsed with the running buffer to remove air bubbles and to displace any storage buffer and residual polyacrylamide.

Wells were loaded with a minimum of 5 μl of marker and the prepared samples (maximum of 40 μl). After placing the lid on the tank and connecting leads to the power supply the gel was run at 150V for 90 minutes. The gels were removed from the tank as soon as possible after the completion of running, before staining or using for another procedure (e.g. Western blot).

Staining and De-Staining of Gels

The gel cassette was opened to remove the gel which was placed into a container or sealable plastic bag. The gel was thoroughly rinsed with tap water, and drained from the container. Coomassie blue stain (approximately 100 ml Gradipure™, Gradipore Limited, Australia)) was added and the container or bag sealed. Major bands were visible in 10 minutes but for maximum intensity, stained overnight. To de-stain the gel, the stain was drained off from the container.

The container and gel were rinsed with tap water to remove residual stain. 6% acetic acid (approximately 100 ml) was poured into the container and sealed. The de-stain was left for as long as it took to achieve the desired level of de-staining (usually 12 hours). Once at the desired level, the acetic acid was drained and the gel rinsed with tap water.

PPV Quantitation

PPV Infectivity Assay

PPV infectivity was assessed by a TCID₅₀ assay in MPK cells. Flat-bottom 96-well plates, seeded with MPK cells, were inoculated 1-2 days later with ten-fold dilutions of PPV virus stock or PPV-spiked electrophoresis samples (filtered through a 0.2 mm filter) and incubated at 37° C. in 5% CO₂ for 10-14 days when the wells were examined for CPE. Six replicates were included for each dilution. Virus titres were calculated as TCID₅₀ using the method of Reed and Muench.

PPV PCR Assay

DNaseI Treatment and DNA Extraction

Two Units of DNaseI (Promega) was added to 180 μl of each sample and incubated at 37° C. for 1 hr in buffer containing 40 mM Tris-HCl (pH 8.0), 10 mM MgSO₄ and 1 mM CaCl₂ (Promega). The reaction was stopped with 20 mM EGTA (pH 8.0). The DNA from DnaseI-treated samples was extracted using phenol-chloroform and DNA was ethanol precipitated according to Sambrook et al, “Molecular Cloning, A Laboratory Manual” second ed., CSH Press, Cold Spring Harbor, 1989 (1989). Extracted DNA was serially diluted 1/10 in H₂O and four replicates of each dilution were subjected to the nested PCR.

Nested PCR

Detection of PPV was performed using a nested PCR adapted from the protocol of Soares et al., J Virol Methods, 78:191-8 (1999). Two outer primers P1 5′-ATACAATTCTATTTCATGGGCCAGC-3′ and P6 5′-TATGTTCTGGTCTTTCCTCGCATC-3′ were used initially to amplify a 330 bp sequence. Primers designed internal to this fragment P2 5′-TTGGTAATGTTGGTTGCTACAATGC-3′ and P5 5′-ACCTGAACATATGGCTTTGAATTGG-3′ were used in the second reaction to yield a 127 bp fragment. Amplifications were done in a DNA thermal cycler (icycler, BioRad). The first reaction was subjected to 95° C. for 5 min prior to 30 cycles at 95° C./15 s, 55° C./15 s and 72° C./10 s. In the second PCR reaction, initial denaturation was 95° C. for 5 min followed by 30 cycles at 95° C./15 s, 55° C./15 s and 72° C./3 s. PCR reactions included the final concentrations of 500 nM of each primer, 200 μM of each dNTP, 1.5 mM MgCl₂, MBI fermentas reaction buffer (10 mM Tris HCl pH 8.8, 50 mM KCl, 0.08% Nonidet P40) and 2.5 U of Taq (MBI fermentas). In the first reaction 5 μl of extracted DNA was used as template and the second reaction contained 5 ml of amplicon from the initial reaction.

Ten μl of product from the second PCR reaction was subjected to electrophoresis on a 10% poly acrylamide gel (BioRad). The gel was stained with 0.5 μg/ml ethidium bromide before visualizing on a UV transilluminator. PCR tires were expressed as log₁₀ genomic equivalents.

Virus Purification Performed on an Electrophoresis Apparatus Using Separation Membranes

Starting material was prepared from harvested porcine parvovirus (PPV) in cell culture media in order to achieve a partially or totally purified, viable virus preparation. The harvested PPV was spiked with extra cell culture media in running buffer to show membrane-based electrophoresis can remove a high level of contamination.

Separation Cartridge: 5/200/5 cartridge (5 kDa molecular mass cut off upper membrane/200 kDa molecular mass cut off separation membrane; 5 kDa molecular mass cut off lower membrane) allowed major contaminants (albumin and transferrin) to pass through to stream 2, restricting PPV in stream 1.

Buffers: Hepes/imidazole pH 7.3 buffer allowed transfer of the major contaminants and approximated physiological pH and assisted in keeping virus viability.

Run times of 120 minutes were used to allow complete transfer of contaminants with the appropriate charge, while restricting PPV in stream 1. 250 volts, 1 amp and 150 watts were applied with forward polarity with the start material in stream 1 and the same volume of running buffer was used in stream 2.

Viral Separation Using Isoelectric Focusing (IEF) Membranes

A membrane-based electrophoresis device (Gradiflow™ developed by Gradipore Limited, Australia) with separate buffer streams was used for runs with IEF membranes to allow two running buffers of different pH to be used (see WO 02/24314). For this series of experiments, an apparatus with isolated buffer chambers forming separate buffer streams was used. The pI of Factor VIII (FVIII) appears to be between 5.2-5.4 and that of PPV 4.6-5. An IEF separation membrane of pH 5.0 was used to separate FVIII and PPV based on their respective pI. Restriction IEF membranes of pH 7.5 and pH 4.0 for the upper and lower buffer streams respectively were also used. All three IEF membranes were manufactured from 1000 kDa glove box produced membranes. The pH acquired by a stream during a run was between that of the two IEF membranes enclosing the stream. It was for this reason the upper restriction membrane was selected at pH 7.5. Stream 1 acquired a pH of approximately 6.0-6.5 which was suitable for maintaining activity of FVIII in electrophoresis separations. The lower restriction membrane of pH 4.0 prevented PPV from migrating to the buffer stream, while allowing the passage of free DNA.

Run Characteristics

pH 8.5 2.7 mM Tris TAPS buffer

pH 7.5 upper membrane

PPV in Milli Q water

pH 5.0 separation membrane

PPV in Milli Q water

pH 4.0 lower membrane

pH 3.0 2.03 mM GABA Lactic acid buffer

The above membrane combination was produced in a cartridge and leak tested in the presence of Milli Q water in stream 1, stream 2 and both electrode buffer streams. Once the leak test was completed, current was applied to the system for two minutes to purge the membranes.

All the water was then drained from the system and the running buffers were added. The upper buffer stream was loaded with pH 8.5 2.7 mM Tris/TAPS buffer and the lower buffer stream was loaded with pH 3.0 2.03 mM GABA/Lactic acid buffer.

Three ml of PPV in 17 ml of Milli Q water was used as starting material. A sample (650 μl) of the starting material was taken for PCR and infectivity analysis. Starting material (9675 μl) was loaded into both the stream 1 and stream 2 reservoirs. 250 V, 150 W, and 1000 mA were applied with forward polarity. Stream 1 and stream 2 volume losses were replaced with Milli Q water.

Purification of PPV from Cell Culture Media

Start material of harvested PPV spiked with extra cell culture media in running buffer was used. A 5 kDa/200 kDa/5 kDa cartridge allowed major contaminants (albumin and transferrin) to pass through to stream 2, restricting PPV in stream 1. Hepes/imidazole pH 7.3 buffer was used, which allowed transfer of the major contaminants and approximated physiological pH and assisted in keeping virus viability. Run times of 2 hours allowed complete transfer of contaminants with the appropriate charge, while restricting PPV in stream 1. 250 volts, 1 amp and 150 watts were applied with forward polarity, with the start material in stream 1 and the same volume of running buffer in stream 2.

### Results

The ability to use isoelectricfocusing (IEF) to recover or purify virus in physiological buffer while simultaneously removing contaminating viruses and proteins based on charge, enables the preparation of a highly refined preparation of a virus vaccine, as established by the following experiments purifying Porcine Parvovirus and removing contaminating proteins (e.g., albumin and transferrin) from tissue culture supernatant by IEF. Separation of two or more different viruses (PPV and HAV or BVDV, for example) has been achieved, demonstrating the potential of the present technology to recover or purify vaccine virus strains from endogenous and adventitious virus contaminations.

Virus Purification Performed on an Electrophoresis Apparatus Using Separation Membranes

The methods described herein resulted in a relatively pure virus product containing some high molecular weight contaminants, with 75% viability of the virus remaining after the run, as determined by infectivity assays.

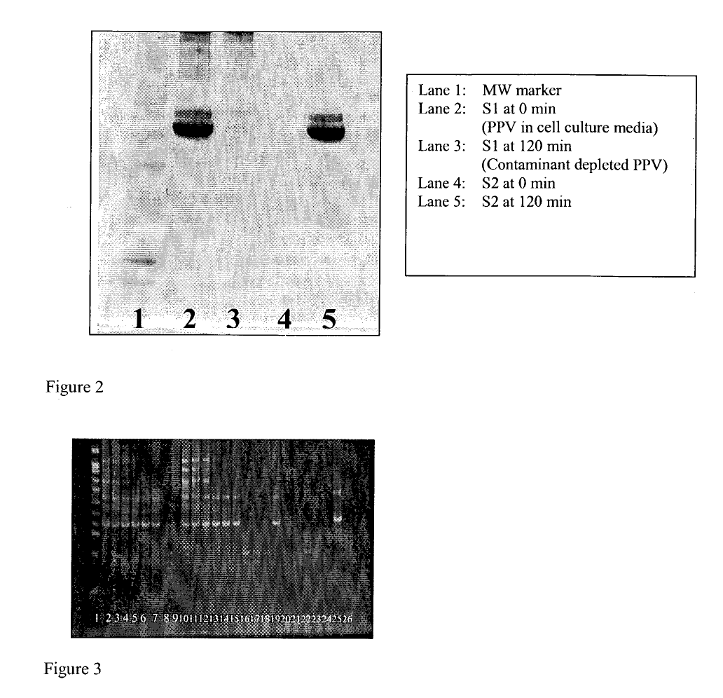

The major protein contaminants albumin and transferrin appeared to completely transfer to stream 2. Additionally, some of the higher and lower molecular weight contaminants were also transferred to stream 2. This can be seen by the SDS-PAGE shown in FIG. 2. Lane 1: MM marker; Lane 2: S1 at 0 min (PPV in cell culture media); Lane 3: S1 at 120 min (Contaminant depleted PPV); Lane 4: S2 at 0 min; Lane 5: S2 at 120 min.

The viral results were determined by a method using PCR with DNase sample pre-treatment and by infectivity assays. By PCR, it was determined that 5 logs of PPV were in the start material at zero time. After 120 minutes, all 5 logs of virus remained in stream 1. The best result achieved gave no detectable virus in stream 2, with no results giving more than 2 logs of virus in stream 2. By infectivity, 75% of the virus contained in the start material was still viable after 120 minutes, with no virus detected in stream 2 samples.

Initial Isoelectric Focusing (IE) Experiments

Cell Culture Media With 2 mM Acid/Base

Three runs were performed using 2 mM NaOH and HCl with 10 kDa polyacrylamide (PAM) restriction membranes and a pH 4.8 IEF separation membrane. All three runs had only a very small amount of protein transfer between streams, as indicated by SDS-PAGE. Start material was loaded in stream two with proteins expected to transfer to stream one due to their pI value relative to the separation membrane and stream pH. However, only a very small amount of one protein transferred to stream one.

Other than lack of protein transfer, harsh running conditions (pH extremes) was another problem encountered during these runs, with the pH of the sample streams found to be quite basic for stream one and acidic for stream two. For the runs that were measured, the pH of stream one (closest to the upper NaOH buffer stream) started at a high pH then fell to around the same, or below that of the IEF separation membrane (pH 11 to ˜pH 4-5). Stream two remained reasonably constant during a run with the pH similar to the lower HCl buffer stream (˜pH 2-3). These conditions were sufficient to destroy most viruses and damage or breakdown many proteins.

Cell Culture Media With 100 mM Acid/Base

To try and minimize the harsh running conditions of the first three runs above and increase protein transfer, amphoteric buffers were added to the sample streams to ensure that the correct pH gradients were maintained throughout the run. The buffer streams contained 100 mM acid and base, used to retain the amphoteric buffers within the sample streams. Initially, PES (polyethyl sulfone) was used for the restriction membranes to provide a stronger barrier between the streams and the 100 mM acid and base. The last run was carried out using 10 kDa PAM restriction membranes to test the effect of the stronger acid and base on the polyacrylamide membranes.

Although slightly better then the 2 mM acid/base runs, protein transfer for this group of runs was still relatively low. The greatest transfer occurred when the start material was in stream two only.

The addition of the amphoteric buffers did have an effect on pH stability compared to the 2 mM acid/base runs. Again, the pH for stream 1 was quite basic at the start of the run (˜pH 10), but did not fall to a much lower value as it had done previously, with the exception of the run using 10 kDa PAM restriction membranes. Instead the pH remained between pH 10-12 throughout the run. The last run that used polyacrylamide restriction membranes (which was the exception), had the pH of stream 1 fall from ˜pH 10 to pH 4-5. Stream 2 started at a higher pH than before due to the amphoteric buffer within the stream and in all but one case, fell to a lower value during the run (pH 4-5 down to pH 2-4). As noted before, these conditions were still sufficient to destroy most viruses and damage or breakdown many proteins.

Viral Separation Using Isoelectric Focusing Membranes

The following results establish that virus may be recovered or purified by the methods described herein using isoelectric focusing (IEF) membranes in a membrane-based electrophoresis system for virus purification and clearance. IEF membranes separate molecules by their pI. These membranes are an alternative to conventional defined pore size separation membranes.

TABLE 1
Results of viral separation using size-based separation

| Sample | PCR (GE) | Infectivity (TCID₅₀/ml) |
|---|---|---|
| Starting material | 10⁴ | 6.66 × 10⁴ |
| Stream 1 - 20 minutes | 10¹ | 0 |
| Stream 1 - 40 minutes | 0 | 0 |
| Stream 1 - 60 minutes | 0 | 0 |
| Stream 2 - 20 minutes | 10⁵ | 2.8 × 10³ |
| Stream 2 - 40 minutes | 10⁵ | 5 × 10³ |
| Stream 2 - 60 minutes | 10³ | 8 × 10² |

Both PCR and infectivity assays confirm that IEF membranes resulted in complete transfer of PPV to stream 2. As shown in Table 1, the PCR results (which detect the presence of virus/virus DNA regardless of viability) indicate that the virus loaded in both streams concentrated into stream 2 during the course of the run. Infectivity tests showed that only 1 log of PPV viability was lost after the transfer.

Purification of PPV from Cell Culture Media

Several run repeats resulted in a relatively pure virus product containing minimal contaminants. The major protein contaminants albumin and transferrin, completely transferred to stream 2. Additionally, some of the higher and lower molecular weight contaminants were transferred to stream 2.

The viral results were determined by PCR with DNase pre-treatment and by TCID₅₀ infectivity assays. By PCR, 5 logs of PPV were found in the start material. After 2 hours, all 5 logs of virus remained in stream 1. The best result achieved gave no virus detectable in stream 2, with no results giving more than 2 logs of virus in stream 2. By infectivity, 75% of the virus present in the start material was still viable after 2 hours, with no virus detected in stream 2 samples. Results are summarized in FIG. 3 and Table 2. In FIG. 3, Lane 1 is the DNA marker; Lanes 2-9 depict the end-point titration of S1 0 min. Lanes 10-18 illustrate the end-point titration of S1 120 min, and lanes 19-26 show the end-point titration of S2 120 min.

TABLE 2
Results of viral separation using charge-based (IEF) separation

| | PCR (Genomic | |
|---|---|---|
| | Equivalents) | Infectivity (TCID₅₀/ml) |
| Steam 1 - 0 minutes | 10⁵ | 8.89 × 10⁴ |
| Stream 1 - 120 minutes | 10⁵ | 6.66 × 10⁴ |
| S2 - 0 minutes | 10⁰ | 10⁰ |
| PPV recovery | 100% | 75% |

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Gradiflow™ is a trade mark of Gradipore Limited, Australia for its membrane-based electrophoresis apparatus.

1. A method of recovering a desired virus type from a mixture of unwanted compounds by electrophoresis, comprising:
(a) placing the mixture in a first sample chamber of an electrophoresis apparatus comprising a separation membrane disposed between the first sample chamber and a second sample chamber;
(b) applying an electric potential across the first and second sample chambers whereby either the desired virus type moves through the separation membrane or the unwanted compounds move through the separation membrane and at least a portion of the desired virus type is located on one side of the separation membrane while unwanted compounds are located on the other side of the separation membrane, and at least about 50% of the desired virus type located on one side of the separation membrane remains viable or substantially unchanged after recovery;
(c) maintaining step (b) until a required amount of the desired virus type is located on one side of the separation membrane; and
(d) recovering the desired virus type.

2. The method according to claim 1 whereby the mixture contains two or more virus types and one virus type is located on one side of the separation membrane in step (b).

3. The method according to claim 2 whereby the mixture contains three or more virus types and more than one virus type is located on one side of the separation membrane in step (b).

4. The method according to claim 3 whereby at least the desired virus type and a second virus type is located on one side of the separation membrane while a third and fourth virus type is located on the other side of the separation membrane in step (b).

5. The method according to claim 1 whereby the desired virus type is selected from the group consisting of parvoviruses, picomaviruses, paramyxoviruses, orthomyxoviruses and flaviviruses.

6. The method according to claim 1 whereby the desired virus type moves through the separation membrane.

7. The method according to claim 2 whereby the desired virus type is located on one side of the separation membrane and the other virus type moves through the separation membrane to the other side of the separation membrane.

8. The method according to claim 1 further including the step of providing a first electrolyte to the first electrolyte chamber and providing a second electrolyte to the second electrolyte chamber.

9. The method according to claim 1 whereby electrolyte is circulated through the electrolyte chamber forming an electrolyte stream.

10. The method according to claim 1 whereby at least one of sample, fluid or electrolyte is passed through a respective chamber forming a stream.

11. The method according to claim 1 whereby electrolyte circulates through the first or second sample chamber forming a first or second sample stream through the first or second sample chamber.

12. The method according to claim 2 whereby the virus types are derived from the same viral species.

13. The method according to claim 11 whereby the virus types are derived from different viral species.

14. The method according to claim 1 whereby substantially all migration across the separation membrane occurs upon the application of the electric potential.

15. The method according to claim 1 whereby step (b) is maintained until the desired virus type reaches a required purity level.

16. The method according to claim 1 whereby the separation membrane has a characteristic average pore size and pore size distribution.

17. The method according to claim 15 whereby the electrophoresis separation membrane is made from polyacrylamide and having a molecular mass cut-off of at least about 5 kDa.

18. The method according to claim 1 whereby the separation membrane is an isoelectric membrane having a characteristic pH value.

19. The method according to claim 17 whereby the isoelectric membrane has a pH value in a range of about 2 to 12.

20. The method according to claim 1 whereby at least about 60% of the desired virus type virus remains viable or substantially unchanged after separation.

21. The method according to claim 1 whereby at least about 70% of the desired virus type remains viable or substantially unchanged after separation.

22. The method according to claim 1 whereby at least about 80% of the desired virus type remains viable or substantially unchanged after separation.

23. The method according to claim 1 whereby about 90% of the desired virus type remains viable or substantially unchanged after separation.

24. The method according to claim 1 wherein the electrophoresis apparatus comprises a first electrolyte chamber, a second electrolyte chamber, a first sample chamber disposed between the first electrolyte chamber and the second electrolyte chamber, a second sample chamber disposed adjacent to the first sample chamber and between the first electrolyte chamber and the second electrolyte chamber, a first ion-permeable barrier disposed between the first sample chamber and the second sample chamber, the first ion-permeable barrier prevents substantial convective mixing of contents of the first and second sample chambers; a second ion-permeable barrier disposed between the first electrolyte chamber and the first sample chamber, the second ion-permeable barrier prevents substantial convective mixing of contents of the first electrolyte chamber and the first sample chamber; a third ion-permeable barrier disposed between the second sample chamber and the second electrolyte chamber, the third ion-permeable barrier prevents substantial convective mixing of contents of the second electrolyte chamber and the second sample chamber; and electrodes disposed in the first and second electrolyte chambers.

25. A method of recovering a desired virus type from a mixture of two or more virus types by electrophoresis, comprising:
(a) placing the mixture in a first sample chamber of an electrophoresis apparatus comprising a separation membrane disposed between the first sample chamber and a second sample chamber;
(b) applying an electric potential across the first and second sample chambers whereby either the desired virus type moves through the separation membrane or other virus types move through the separation membrane and at least a portion of the desired virus type is located on one side of the separation membrane while unwanted viruses are located on the other side of the separation membrane, and at least about 50% of the desired virus type located on one side of the separation membrane remains viable or substantially unchanged after recovery;
(c) maintaining step (b) until a required amount of the desired virus type is located on one side of the separation membrane; and
(d) recovering the desired virus type.

26. The method according to claim 25 whereby the mixture contains three or more virus types and more than one virus type is located on one side of the separation membrane in step (b).

27. The method according to claim 26 whereby at least a first and second virus type is located on one side of the separation membrane while a third and fourth virus type is located on the other side of the separation membrane in step (b).

28. The method according to claim 25 whereby the desired virus type is selected from the group consisting of parvoviruses, picomaviruses, paramyxoviruses, orthomyxoviruses and flaviviruses.

29. The method according to claim 25 whereby the desired virus type moves through the separation membrane.

30. The method according to claim 25 whereby the desired virus type is located on one side of the separation membrane and the undesired virus type moves through the separation membrane to the other side of the separation membrane.

31. The method according to claim 25 further including the step of providing a first electrolyte to the first electrolyte chamber and providing a second electrolyte to the second electrolyte chamber.

32. The method according to claim 25 whereby electrolyte is circulated through the electrolyte chamber forming an electrolyte stream.

33. The method according to claim 25 whereby at least one of sample, fluid or electrolyte is passed through a respective chamber forming a stream.

34. The method according to claim 25 whereby electrolyte circulates through the first or second sample chamber forming a first or second sample stream through the first or second sample chamber.

35. The method according to claim 25 whereby the virus types are derived from the same viral species.

36. The method according to claim 35 whereby the virus types are derived from different viral species.

37. The method according to claim 25 whereby substantially all migration across the separation membrane occurs upon the application of the electric potential.

38. The method according to claim 25 whereby step (b) is maintained until the desired virus type reaches a required purity level.

39. The method according to claim 25 whereby the separation membrane has a characteristic average pore size and pore size distribution.

40. The method according to claim 39 whereby the electrophoresis separation membrane is made from polyacrylamide and having a molecular mass cut-off of at least about 5 kDa.

41. The method according to claim 25 whereby the separation membrane is an isoelectric membrane having a characteristic pH value.

42. The method according to claim 41 whereby the isoelectric membrane has a pH value in a range of about 2 to 12.

43. The method according to claim 25 whereby at least about 60% of the desired virus type remains viable or substantially unchanged after separation.

44. The method according to claim 25 whereby at least about 70% of the desired virus type remains viable or substantially unchanged after separation.

45. The method according to claim 25 whereby at least about 80% of the desired virus type remains viable or substantially unchanged after separation.

46. The method according to claim 25 whereby about 90% of the desired virus type remains viable or substantially unchanged after separation.

47. The method according to claim 25 wherein the electrophoresis apparatus comprises a first electrolyte chamber, a second electrolyte chamber, a first sample chamber disposed between the first electrolyte chamber and the second electrolyte chamber, a second sample chamber disposed adjacent to the first sample chamber and between the first electrolyte chamber and the second electrolyte chamber, a first ion-permeable barrier disposed between the first sample chamber and the second sample chamber, the first ion-permeable barrier prevents substantial convective mixing of contents of the first and second sample chambers; a second ion-permeable barrier disposed between the first electrolyte chamber and the first sample chamber, the second ion-permeable barrier prevents substantial convective mixing of contents of the first electrolyte chamber and the first sample chamber; a third ion-permeable barrier disposed between the second sample chamber and the second electrolyte chamber, the third ion-permeable barrier prevents substantial convective mixing of contents of the second electrolyte chamber and the second sample chamber; and electrodes disposed in the first and second electrolyte chambers.

48. A method of recovering at least one virus type from a sample by electrophoresis, the method comprising the steps of:
(a) providing sample containing at least one virus type to an electrophoresis apparatus comprising a first electrolyte chamber, a second electrolyte chamber, a first sample chamber disposed between the first electrolyte chamber and the second electrolyte chamber, a second sample chamber disposed adjacent to the first sample chamber and between the first electrolyte chamber and the second electrolyte chamber, a first ion-permeable barrier disposed between the first sample chamber and the second sample chamber, the first ion-permeable barrier prevents substantial convective mixing of contents of the first and second sample chambers; a second ion-permeable barrier disposed between the first electrolyte chamber and the first sample chamber, the second ion-permeable barrier prevents substantial convective mixing of contents of the first electrolyte chamber and the first sample chamber; a third ion-permeable barrier disposed between the second sample chamber and the second electrolyte chamber, the third ion-permeable barrier prevents substantial convective mixing of contents of the second electrolyte chamber and the second sample chamber; and electrodes disposed in the first and second electrolyte chambers; and
(b) applying an electric potential between the electrodes causing at least one virus type in the first or second sample chamber to move through the first ion-permeable barrier into the other of the first or second sample chamber; or alternatively, causing components other than the one virus type in the first or second sample chamber to move through the first ion-permeable barrier into the other of the first or second sample chamber, whereby at least about 50% of the at least one virus type virus remains viable or substantially unchanged after recovery;
(c) maintaining step (b) until a required amount of the desired virus type is located on one side of the separation membrane; and
(d) recovering the desired virus type.

49. The method according to claim 48 whereby the apparatus further comprises a first electrolyte reservoir in fluid communication with an electrolyte chamber; a first sample reservoir in fluid communication with the first sample chamber, a second sample reservoir in fluid communication with the second sample chamber; means to provide electrolyte to the electrolyte chambers and means to provide sample or fluid to the first and second sample chambers.

50. The method according to claim 49 whereby content of both a first and second sample reservoirs circulate through the respective first and second sample chambers forming first and second sample streams through the first and second sample chambers.

51. The method according to claim 49 whereby sample or liquid in a first or second sample reservoir is removed and replaced with fresh sample or liquid.

52. The method according to claim 48 whereby the second and third ion-permeable barriers are restriction membranes having a molecular mass cut off less than that of the first ion-permeable barrier.

52. The method according to claim 48 whereby the ion-permeable barriers are membranes having a characteristic average pore size and pore size distribution.

54. The method according to claim 48 whereby at least one of the second or third ion-permeable barriers is an isoelectric membrane having a characteristic pH value.

55. The method according to claim 49 whereby the at least one isoelectric membrane has a pH value in a range of about 2 to 12.

56. The method according to claim 49 whereby the second and third ion-permeable barriers are isoelectric membranes having the same characteristic pH values.

57. The method according to claim 49 whereby the second and third ion-permeable barriers are isoelectric membranes having different characteristic pH values.

58. The method according to claims 48 or 49 whereby the isoelectric membrane is an Immobiline™ polyacrylamide membrane.
